(19) United States
(12) Patent Application Publication
(10) Pub. No.: US 2025/0173243 A1
(43) Pub. Date: May 29, 2025

(54) MONITORING SYSTEM, MONITORING DEVICE, MONITORING METHOD, AND RECORDING MEDIUM

(71) Applicant: Panasonic Automotive Systems Co., Ltd., Kanagawa (JP)

(72) Inventors: Tadahiro UCHIKOSHI, Tokyo (JP); Kazuki KUZU, Kanagawa (JP); Toshinari MORIKAWA, Kanagawa (JP)

(73) Assignee: Panasonic Automotive Systems Co., Ltd., Kanagawa (JP)

(21) Appl. No.: 18/952,271

(22) Filed: Nov. 19, 2024

(30) Foreign Application Priority Data
Nov. 24, 2023 (JP) 2023-199149

(51) Int. Cl. G06F 11/34

(52) U.S. Cl. CPC G06F 11/3495

(57) ABSTRACT

A monitoring system that monitors the processing load of a physical device equipped in a vehicle including a first controller and a second controller that cause the physical device to execute a process, includes: an obtainer that obtains a first counter value, which is a count of executions of a predetermined process that the first controller causes the physical device to execute, and a second counter value, which is a count of executions of the predetermined process that the second controller causes the physical device to execute; and a calculator that calculates the usage rate of the physical device in each of the first controller and the second controller based on the obtained first counter value and second counter value.

### CROSS REFERENCE TO RELATED APPLICATIONS

The present application is based on and claims priority of Japanese Patent Application No. 2023-199149 filed on Nov. 24, 2023.

### FIELD

The present disclosure relates to a monitoring system, a monitoring device, a monitoring method, and a recording medium.

### BACKGROUND

Patent Literature (PTL) 1 discloses a performance monitoring system that, in a system where a plurality of virtual computers (control units) share physical devices, determines bottlenecks by considering physical device allocation policies and impact on software.

### CITATION LIST

### Patent Literature

PTL 1: Japanese Unexamined Patent Application Publication No. 2010-250689

### SUMMARY

However, the performance monitoring system in PTL 1 can be improved upon.

In view of this, the present disclosure provides a monitoring system, a monitoring device, a monitoring method, and a recording medium that are capable of improving upon the above related art.

A monitoring system according to one aspect of the present disclosure monitors a processing load of a physical device equipped in a vehicle including a first controller and a second controller that are configured to cause the physical device to execute a process, and includes: an obtainer configured to obtain a first counter value and a second counter value, the first counter value being a count of executions of a predetermined process that the first controller causes the physical device to execute, the second counter value being a count of executions of the predetermined process that the second controller causes the physical device to execute; and a calculator configured to calculate a usage rate of the physical device in each of the first controller and the second controller based on the first counter value obtained and the second counter value obtained.

A monitoring device according to one aspect of the present disclosure is for monitoring a processing load of a physical device equipped in a vehicle including a first controller and a second controller that are configured to cause the physical device to execute a process, and includes: a first monitor configured to count executions of a predetermined process that the first controller causes the physical device to execute; a second monitor configured to count executions of the predetermined process that the second controller causes the physical device to execute; and an outputter configured to output a first counter value of the count by the first monitor and a second counter value of the count by the second monitor.

A monitoring method according to one aspect of the present disclosure is a method of monitoring a processing load of a physical device equipped in a vehicle including a first controller and a second controller that cause the physical device to execute a process, and includes: obtaining a first counter value and a second counter value, the first counter value being a count of executions of a predetermined process that the first controller causes the physical device to execute, the second counter value being a count of executions of the predetermined process that the second controller causes the physical device to execute; and calculating a usage rate of the physical device in each of the first controller and the second controller based on the first counter value obtained and the second counter value obtained.

A recording medium according to one aspect of the present disclosure is a non-transitory computer-readable recording medium for use in a computer, the recording medium having a computer program recorded thereon for causing the computer to execute the above monitoring method.

### Advantageous Effects

The monitoring system, etc., according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates the configuration of a monitoring system according to an embodiment of the present disclosure.

FIG. 2 is a block diagram illustrating the functional configuration of a visualization processing device according to an embodiment of the present disclosure.

FIG. 3 is a flowchart illustrating operations performed by a monitoring system according to an embodiment of the present disclosure.

FIG. 4 illustrates various information according to an embodiment of the present disclosure.

FIG. 5 is a flowchart illustrating storage operations performed by an ECU according to an embodiment of the present disclosure.

FIG. 6 is a flowchart illustrating operations performed by a monitoring system according to a variation of an embodiment of the present disclosure.

### DESCRIPTION OF EMBODIMENT(S)

### Knowledge Leading to the Present Disclosure

When there are a plurality of controllers that share a physical device, being able to easily obtain the processing load of each controller is desirable.

In view of this, the present disclosure provides a monitoring system, a monitoring device, a monitoring method, and a recording medium, further improving upon the related art by enabling easy obtainment of the processing load of a plurality of controllers that share a physical device.

Hereinafter, embodiments of the present disclosure will be described in detail with reference to the drawings.

The embodiments described below each illustrate a general or specific example of the present disclosure. The numerical values, shapes, materials, elements, the arrangement and connection of the elements, etc., shown in the following embodiments are mere examples, and therefore do not limit the scope of the present disclosure.

### Embodiment

Hereinafter, the monitoring system, etc., according to an embodiment of the present disclosure will be described.

### 1. Configuration of Monitoring System

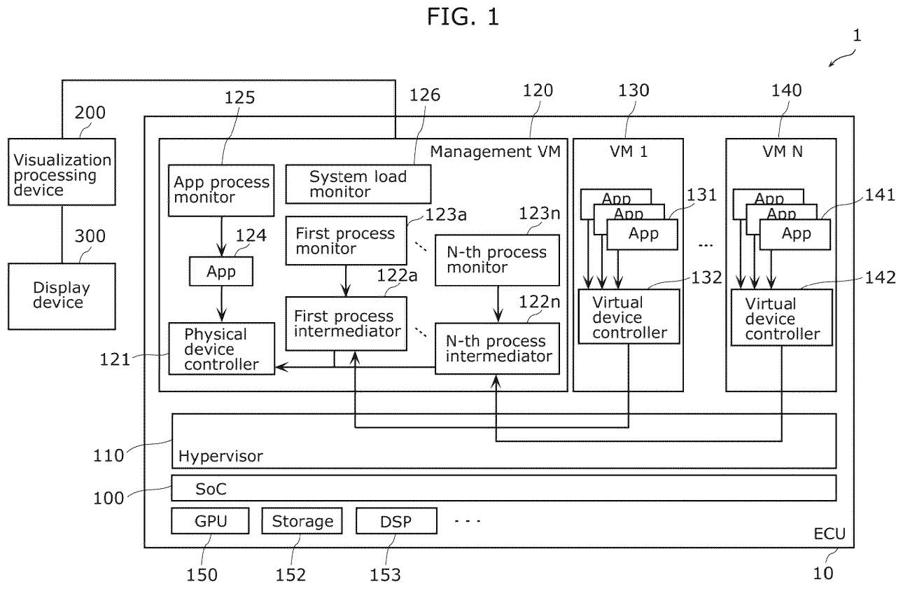

FIG. 1 illustrates the configuration of monitoring system 1 according to the present embodiment. Monitoring system 1 is a system for monitoring the processing load of a physical device equipped in a vehicle.

As illustrated in FIG. 1, monitoring system 1 includes electronic control unit (ECU) 10, visualization processing device 200, and display device 300.

ECU 10 is equipped in a vehicle, and is a computer including a processor (microprocessor) and memory, among other components. The memory includes read-only memory (ROM) and random access memory (RAM), and can store programs executed by the processor.

ECU 10 may be realized by an ECU acting as a centralized zone ECU that controls the entire vehicle (also referred to as an integrated ECU). An integrated ECU is a central ECU where a plurality of ECUs are integrated. An integrated ECU is a central ECU where, due to the increasing complexity of vehicle systems, functions previously distributed across multiple ECUs are integrated into one ECU to resolve issues such as of growing development periods or costs. Such an integrated ECU utilizes virtualization technology to operate a plurality of virtual computers (virtual machines (VMs)) within a single ECU. A zone ECU is arranged in a vehicle and controls resources in the arranged region. For example, a zone ECU is connected to equipment in a vehicle and controls the connected equipment.

In ECU 10, hypervisor 110 operates on system on a chip (SoC) 100, which is hardware, virtual machines operate on hypervisor 110, and different operating systems operate on different virtual machines. SoC 100 represents a machine or device capable of receiving data, performing logical operations on data, storing data, and displaying data. Soc 100 is not limited to these examples, and may include a processor and memory.

Hypervisor 110 is software serving as a virtualization foundation that operates one or more virtual machines (in the example of FIG. 1, a plurality of virtual machines).

The virtual machines include management virtual machine 120 (management VM in FIG. 1) and a plurality of control virtual machines (N control virtual machines in FIG. 1 (N being an integer of 2 or greater)) including control virtual machine 130 (VM 1 in FIG. 1) and control virtual machine 140 (VM N in FIG. 1). Management virtual machine 120 is one example of a manager or monitoring device, control virtual machine 130 is one example of a first controller, and control virtual machine 140 is one example of a second controller.

Management virtual machine 120 is a virtual machine that operates on hypervisor 110, and is provided to monitor a processing load of a physical device equipped in a vehicle.

Management virtual machine 120 centrally manages access to the physical device of the control virtual machines. For example, management virtual machine 120 manages communication between the control virtual machines and graphics processing unit (GPU) 150, storage 152, and digital signal processor (DSP) 153, which are each one example of a physical device. Management virtual machine 120 includes physical device controller 121, a plurality of process intermediators including first process intermediator 122a and N-th process intermediator 122n, a plurality of process monitors including first process monitor 123a and N-th process monitor 123n, application 124 (denoted as “app” in management virtual machine 120 in FIG. 1), app process monitor 125, and system load monitor 126.

Physical device controller 121 is communicably connected to a physical device and controls the physical device based on control signals for the physical device that are obtained from the process intermediators or application 124. The control signals from the control virtual machines and application 124 are input to the physical device via physical device controller 121.

The number of process intermediators provided, including first process intermediator 122a and N-th process intermediator 122n, is the same as the number of control virtual machines provided (for example, they are provided in one-to-one correspondence), and the process intermediators act as an intermediary for the control signals from the control virtual machines to the physical device. More specifically, first process intermediator 122a obtains the control signal from control virtual machine 130, and outputs the obtained control signal to physical device controller 121. First process intermediator 122a may output the control signal to physical device controller 121 each time it obtains the control signal from control virtual machine 130, and, alternatively, may queue control signals obtained from control virtual machine 130 and output the control signals in a predetermined sequence or output a predetermined number of the control signals to physical device controller 121.

When ECU 10 includes shared memory (not illustrated) that stores the control signals from the control virtual machines, first process intermediator 122a may obtain a control signal from control virtual machine 130 by reading the control signal output from control virtual machine 130 and stored in the shared memory.

N-th process intermediator 122n obtains the control signal from control virtual machine 140, and outputs the obtained control signal to physical device controller 121. N-th process intermediator 122n may output the control signal to physical device controller 121 each time it obtains the control signal from control virtual machine 140, and, alternatively, may queue control signals obtained from control virtual machine 140 and output the control signals in a predetermined sequence or output a predetermined number of the control signals to physical device controller 121.

N-th process intermediator 122n may obtain the control signal from control virtual machine 140 by reading the control signal output from control virtual machine 140 and stored in the shared memory.

The process monitors including first process monitor 123a and N-th process monitor 123n perform monitoring for calculating a processing load placed on the physical device by each of the control virtual machines. The process monitors monitor the process intermediators using the same program, and measure processing amounts of predetermined processes performed by a plurality of virtual device controllers including virtual device controllers 132 and 142. In one non-limiting example, the processing amount is the number of processes.

First process monitor 123a monitors (for example, calculates) the processing amount of a predetermined process control virtual machine 130 causes the physical device to execute. In the present embodiment, first process monitor 123a counts the number of times control virtual machine 130 causes the physical device to execute the predetermined process. For example, first process monitor 123a counts each time first process intermediator 122a outputs a control signal from control virtual machine 130 or each time first process intermediator 122a obtains a control signal from control virtual machine 130. In the present embodiment, first process monitor 123a increments the counter value each time first process intermediator 122a outputs a control signal from control virtual machine 130. The initial counter value is, for example, zero.

First process monitor 123a also executes a process for outputting the counted counter value to visualization processing device 200. First process monitor 123a functions as an outputter.

N-th process monitor 123n monitors (for example, calculates) the processing amount of predetermined processes control virtual machine 140 causes the physical device to execute. In the present embodiment, N-th process monitor 123n counts the number of times control virtual machine 140 causes the physical device to execute the predetermined process. For example, N-th process monitor 123n counts each time N-th process intermediator 122n outputs a control signal from control virtual machine 140 or each time N-th process intermediator 122n obtains a control signal from control virtual machine 140. In the present embodiment, N-th process monitor 123n increments the counter value each time N-th process intermediator 122n outputs a control signal from control virtual machine 140. The initial counter value is, for example, zero.

N-th process monitor 123n also executes a process for outputting the counted counter value to visualization processing device 200. N-th process monitor 123n functions as an outputter.

The other process monitors also perform the same processes.

Here, the process monitors count only predetermined control signals from among control signals from the control virtual machine. The process monitors count the predetermined control signals based on common monitoring content. For example, when monitoring the processing load of a particular physical device among the physical devices, common monitoring content includes counting control signals to that particular physical device. When the particular physical device is GPU 150, i.e., when the processing load of GPU 150 is monitored, first process monitor 123a counts only those control signals destined for GPU 150 from among control signals destined for physical devices from control virtual machine 130. For example, first process monitor 123a increments the counter value when first process intermediator 122a outputs a control signal to GPU 150, and does not increment the counter value when first process intermediator 122a outputs a control signal to a physical device other than GPU 150.

Similarly, when the particular physical device is GPU 150, N-th process monitor 123n counts only those control signals destined for GPU 150 from among control signals destined for physical devices from control virtual machine 140. For example, N-th process monitor 123n increments the counter value when N-th process intermediator 122n outputs a control signal to GPU 150, and does not increment the counter value when N-th process intermediator 122n outputs a control signal to a physical device other than GPU 150.

The common monitoring content includes counting control signals with respect to a particular physical device and a particular process. When the particular physical device is GPU 150 and the particular process is transferring an image, first process monitor 123a counts only those control signals that are for transferring an image and are destined for GPU 150 from among control signals destined for physical devices from control virtual machine 130. In the present embodiment, first process monitor 123a increments the counter value when first process intermediator 122a outputs, to GPU 150, a control signal for transferring an image, and does not increment the counter value when first process intermediator 122a outputs, to GPU 150, a control signal for something other than transferring an image or when first process intermediator 122a outputs a control signal to a physical device other than GPU 150. First process monitor 123a can be considered to count how many times an image is transferred from GPU 150 to control virtual machine 130. Image transfer is one example of the predetermined process.

Similarly, when the particular physical device is GPU 150 and the particular process is transferring an image, N-th process monitor 123n counts only those control signals that are for transferring an image and are destined for GPU 150 from among control signals destined for physical devices from control virtual machine 140. In the present embodiment, N-th process monitor 123n increments the counter value when N-th process intermediator 122n outputs, to GPU 150, a control signal for transferring an image, and does not increment the counter value when N-th process intermediator 122n outputs, to GPU 150, a control signal for something other than transferring an image or when N-th process intermediator 122n outputs a control signal to a physical device other than GPU 150. N-th process monitor 123n can be considered to count how many times an image is transferred from GPU 150 to control virtual machine 140.

Note that the process to be counted may differ from physical device to physical device. When the physical device is storage 152, i.e., when the processing load of storage 152 is monitored, the process to be counted may be, for example, deletion of a predetermined amount of data. When the physical device is DSP 153, i.e., when the processing load of DSP 153 is monitored, the process to be counted may be, for example, filter processing applied to digital data such as an image. The process to be counted is one example of the predetermined process.

In this way, first process monitor 123a functions as a first monitor that counts the number of executions of a predetermined process control virtual machine 130 causes a physical device to execute, and N-th process monitor 123n functions as a second monitor that counts the number of executions of a predetermined process control virtual machine 140 causes a physical device to execute.

Note that the process monitors are not limited to a configuration including management virtual machine 120. For example, each control virtual machine may include a process monitor that performs counting operations for the device it is included in. For example, control virtual machine 130 may include a process monitor that counts the number of times virtual device controller 132 outputs a control signal to management virtual machine 120. For example, control virtual machine 140 may include a process monitor that counts the number of times virtual device controller 142 outputs a control signal to management virtual machine 120.

Note that the process monitors may log the counted counter value and output the log to the in-vehicle network. For example, the output log may be stored in a storage unit (not illustrated) provided in the vehicle. In one non-limiting example, the storage unit is realized as semiconductor memory.

Application 124 is an application whose purpose is something other than management of the control virtual machines (a typical application in a vehicle), and in the present embodiment, is an application for executing a process utilizing the physical device. Application 124 may be an application for controlling an image to be displayed to an occupant of the vehicle, may be an application for controlling data stored in storage 152, may be an application for controlling an operation related to driving on the vehicle, and may be some other application.

App process monitor 125 performs monitoring for calculating a processing load placed on the physical device by application 124. App process monitor 125 monitors application 124 using the same program as the process monitors, and calculates the processing amount of a predetermined process executed by application 124. In one non-limiting example, the processing amount is the number of processes.

More specifically, app process monitor 125 counts each time application 124 outputs a control signal for controlling the physical device to physical device controller 121. In the present embodiment, app process monitor 125 increments the counter value each time application 124 outputs a control signal to physical device controller 121. The initial counter value is, for example, zero. App process monitor 125 is one example of a third monitor that counts the number of executions of a predetermined process executed on a physical device by application 124.

Just like the process monitors, app process monitor 125 counts based on common monitoring content. In other words, app process monitor 125 and each process monitor count the number of times a predetermined process is executed using the same monitoring method. For example, when the particular physical device is GPU 150, i.e., when the processing load of GPU 150 is monitored, app process monitor 125 counts only those control signals destined for GPU 150 from among control signals destined for physical devices from application 124. For example, app process monitor 125 increments the counter value when application 124 outputs a control signal to GPU 150, and does not increment the counter value when application 124 outputs a control signal to a physical device other than GPU 150.

For example, when the particular physical device is GPU 150 and the particular process is transferring an image, app process monitor 125 counts only those control signals that are for transferring an image and are destined for GPU 150 from among control signals destined for physical devices from application 124. In the present embodiment, app process monitor 125 increments the counter value when application 124 outputs, to GPU 150, a control signal for transferring an image, and does not increment the counter value when application 124 outputs, to GPU 150, a control signal for something other than transferring an image or when application 124 outputs a control signal to a physical device other than GPU 150. App process monitor 125 can be considered to count how many times an image is transferred from GPU 150 to application 124. Image transfer is one example of the predetermined process.

In this way, app process monitor 125 monitors application 124 using the same monitoring content (the same physical device and the same counting method) as the process monitors.

App process monitor 125 also executes a process for outputting the counted counter value to visualization processing device 200. App process monitor 125 functions as an outputter.

System load monitor 126 monitors the usage rate of the physical device. For example, system load monitor 126 monitors the processing load of GPU 150, the band (i.e., the communication speed) of the access network of storage 152, and/or the processing load of DSP 153.

As described above, management virtual machine 120 also functions as an app executor that executes an application program. The application program may be a program for executing a process related to the vehicle. By monitoring the process intermediators and application 124, the processing load of management virtual machine 120 and the processing load of the control virtual machines can be managed separately.

Although management virtual machine 120 is exemplified as including one pair of application 124 and app process monitor 125 in the above embodiment, management virtual machine 120 may include a plurality of pairs of application 124 and app process monitor 125. Moreover, management virtual machine 120 does not need to include application 124 and app process monitor 125.

Control virtual machines 130 and 140 cause the physical device to execute a process via management virtual machine 120.

Control virtual machine 130 includes one or more applications 131 and virtual device controller 132.

Application 131 is a typical application in a vehicle, and in the present embodiment, is an application for executing a process utilizing the physical device. Application 131 may be an application that controls an image to be displayed to an occupant of the vehicle, may be an application that controls data stored in storage 152, may be an application that controls an operation related to driving on the vehicle, and may be some other application.

Virtual device controller 132 is communicably connected to management virtual machine 120, and outputs, to first process intermediator 122a, a control signal from application 131.

Control virtual machine 140 has the same configuration as control virtual machine 130, and includes one or more applications 141 and virtual device controller 142.

Note that the control device is configured by a plurality of control virtual machines including at least control virtual machines 130 and 140.

Note that the number of control virtual machines included in ECU 10 is not limited to N. For example, when management virtual machine 120 does not include application 124, it is sufficient if ECU 10 includes two or more control virtual machines. For example, when management virtual machine 120 includes application 124 and app process monitor 125, it is sufficient if ECU 10 includes one or more control virtual machines.

Visualization processing device 200 executes processing for visualizing information related to the processing load placed on physical device by management virtual machine 120 and the control virtual machines, based on the counter values of the counts by app process monitor 125 and the process monitors. Visualization processing device 200 is communicably connected to ECU 10 and display device 300, obtains the counter value from ECU 10, and outputs, to display device 300, presentation information for visualizing the processing load based on the obtained counter value. Visualization processing device 200 is one example of the processing device.

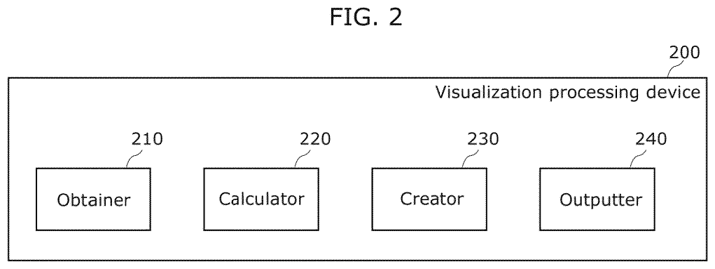

FIG. 2 is a block diagram illustrating the functional configuration of visualization processing device 200 according to the present embodiment.

As illustrated in FIG. 2, visualization processing device 200 includes obtainer 210, calculator 220, creator 230, and outputter 240. Note that it is sufficient so long as visualization processing device 200 includes at least obtainer 210 and calculator 220.

Visualization processing device 200 includes, for example, a processor and memory. The memory is, for example, ROM and/or RAM, and is capable of storing a program to be executed by the processor. For example, the functions of the visualization processing device 200 are realized by the processor executing a program stored in the memory.

Obtainer 210 is capable of communicating with ECU 10, and obtains a first counter value which is a count of executions of a predetermined process that control virtual machine 130 causes the physical device to execute in a predetermined period, and a second counter value which is a count of executions of the predetermined process that control virtual machine 140 causes the physical device to execute. In the present embodiment, obtainer 210 further obtains a third counter value which is a count of executions of the predetermined process that application 124 causes the physical device to execute in a predetermined period. In other words, obtainer 210 obtains N+1 counter values in a predetermined period. The first counter value is a counter value of the count by first process monitor 123a, the second counter value is a counter value of the count by N-th process monitor 123n, and the third counter value is a counter value of the count by app process monitor 125.

For example, obtainer 210 includes a communications interface for communicating with ECU 10.

Calculator 220 calculates the device usage rate of each virtual machine based on the obtained counter values. In the present embodiment, calculator 220 calculates the device usage rate of management virtual machine 120 and each of the control virtual machines based on the N+1 counter values corresponding to the predetermined period. Calculator 220 calculates the device usage rate of each virtual machine based on Equation 1 shown below. Note that each virtual machine includes management virtual machine 120 and a plurality of control virtual machines.

Device usage rate of virtual machine [%]=usage rate [%] of physical device×(process monitor counter value/sum of all process monitor counter values) (Equation 1)

In this way, calculator 220 calculates the processing load placed on a physical device by management virtual machine 120 and the control virtual machines by proportionally dividing the actual usage rate of the physical device by the counter value (i.e., the number of executions of a process). Assuming the total of the counter values of each process monitor corresponds to the system-wide load, calculator 220 can be considered to calculate the processing load of each virtual machine as a value proportionally divided by the counter values.

Next, calculation of the device usage rate when ECU 10 includes two control virtual machines, namely control virtual machines 130 and 140, as the plurality of control virtual machines, will be explained.

For example, when calculating the device usage rate of control virtual machine 130, the first counter value is inserted in Equation 1 as the process monitor counter value. Stated differently, calculator 220 calculates the device usage rate of control virtual machine 130 by considering the first counter value of the count by first process monitor 123a as the processing load resulting from virtual device controller 132 of control virtual machine 130 requesting processing from the physical device. Calculator 220 calculates the device usage rate for control virtual machine 140 in a similar manner.

For example, calculator 220 calculates, based on the first counter value and the sum of the counter values of each control virtual machine including at least the first counter value and the second counter value, the usage rate of the physical device in control virtual machine 130 (one example of the first usage rate), and based on the second counter value and said sum, calculates the usage rate of the physical device in control virtual machine 140 (one example of the second usage rate). In the present embodiment, calculator 220 calculates, based on the first counter value and the sum of the first counter value, the second counter value, and the third counter value of management virtual machine 120, the usage rate of the physical device in control virtual machine 130, and based on the second counter value and said sum, calculates the usage rate of the physical device in control virtual machine 140.

For example, when calculating the device usage rate of management virtual machine 120, the third counter value is inserted as the process monitor counter value. For example, calculator 220 calculates, based on the third counter value and the sum of the first, second, and third counter values, the third usage rate of the physical device in management virtual machine 120.

Note that the physical device usage rate may be obtained from system load monitor 126. The sum of the counter values of all process monitors may be a value obtained by totaling the N+1 counter values in the predetermined period. In this way, calculator 220 calculates the device usage rate of each virtual machine based on a ratio including the counter values. Summing the device usage rates of each virtual machine results in a value consistent with the usage rate of the physical device.

Note that calculator 220 is not limited to calculating the device usage rate using Equation 1 described above. For example, calculator 220 may obtain the device usage rate of a virtual machine using a lookup table where physical device usage rates and counter values (or counter values and the sum of all counter values) are correlated with device usage rates.

Creator 230 creates display data for visualizing the device usage rate of each virtual machine calculated by calculator 220.

Outputter 240 is capable of communicating with ECU 10 and display device 300, and outputs the display data created by creator 230 to display device 300. For example, outputter 240 includes a communications interface for communicating with ECU 10 and display device 300.

Note that in addition to the above, visualization processing device 200 may also include, for example, a receiver for receiving user input. Non-limiting examples of the receiver include a button, a mouse, a touch panel, and a microphone.

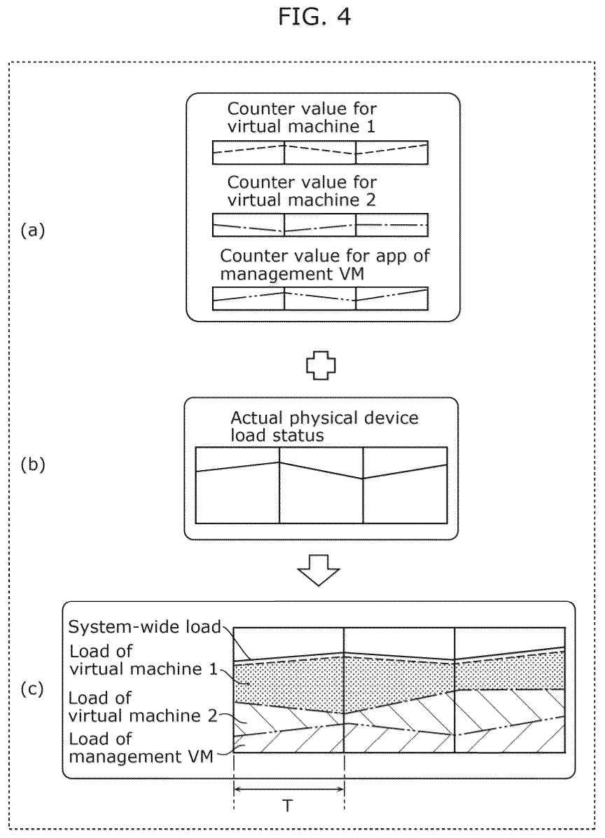

Display device 300 displays the display data created by visualization processing device 200. Display device 300 displays information indicating at least the processing load placed on the physical device by each control virtual machine. More specifically, display device 300 displays information indicating at least the device usage rate of each control virtual machine. In the present embodiment, display device 300 displays information indicating the device usage rate of management virtual machine 120 and each control virtual machine. The display performed by display device 300 will be described later with reference to FIG. 4. Display device 300 is, for example, realized by a liquid crystal display device. Display device 300 is one example of the display.

### 2. Operations Performed by Monitoring System

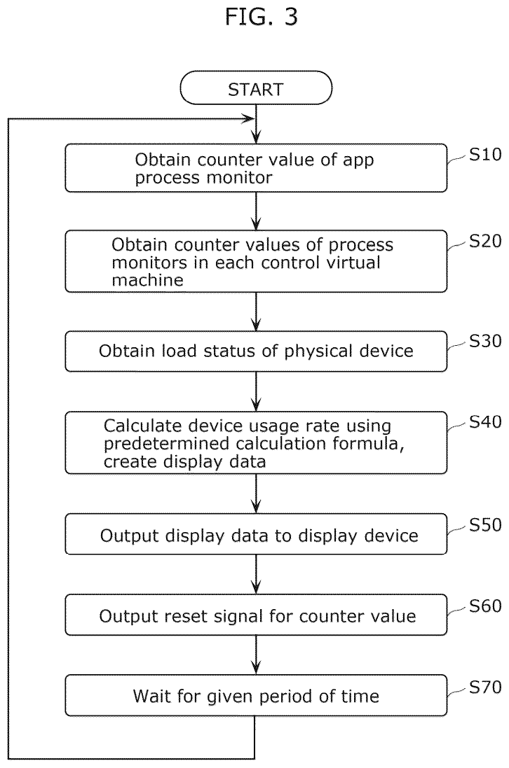

Next, operations performed by monitoring system 1 configured as described above will be described with reference to FIG. 3 to FIG. 5. FIG. 3 is a flowchart illustrating operations (the monitoring method) performed by monitoring system 1 according to the present embodiment. FIG. 3 illustrates operations executed by visualization processing device 200. FIG. 4 illustrates various information according to the present embodiment. In (a) to (c) in FIG. 4, time is represented on the horizontal axes of the graphs, and each graph depicts the same span of time (predetermined period). Note that FIG. 4 illustrates an example including two control virtual machines, namely virtual machines 1 and 2, as the plurality of control virtual machines. Note that in the following description, virtual machine 1 is control virtual machine 130, virtual machine 2 is control virtual machine 140, and the management VM is management virtual machine 120.

As illustrated in FIG. 3, obtainer 210 obtains the counter value (the third counter value) of app process monitor 125 in the predetermined period (S10) and obtains the counter values (the first counter value and the second counter value) of the process monitors in each control virtual machine (here, control virtual machines 130 and 140) in the same predetermined period (S20). For example, in step S20, obtainer 210 obtains N counter values including the first counter value and the second counter value, which were counted by N process monitors in the predetermined period. Note that the timing for obtainer 210 to obtain each counter value is not particularly limited; the obtainment may be performed periodically or based on a request from visualization processing device 200.

In (a) in FIG. 4, the counter values are represented on the vertical axis of the graph. For example, as illustrated in (a) in FIG. 4, in step S10, obtainer 210 obtains time-series data of counter values of virtual machines 1 and 2 over a predetermined period. For example, as illustrated in (a) in FIG. 4, in step S10, obtainer 210 obtains the counter value of the app of the management VM. Note that in the example of (a) in FIG. 4, the predetermined period is divided into three subperiods, and an example showing the obtainment of counter values for each of the three subperiods is illustrated. The three subperiods of virtual machines 1 and 2 and the three subperiods of the app of the management VM are identical.

Referring again to FIG. 3, next, obtainer 210 obtains the load status of the physical device in the predetermined period (S30). Obtainer 210 may obtain the physical device usage rate measured by system load monitor 126 as the load status, and, for example, may obtain said usage rate through user input.

In (b) in FIG. 4, the device usage rate (as a percentage) is represented on the vertical axis of the graph. For example, as illustrated in (b) in FIG. 4, in step S30, obtainer 210 obtains time-series data of the physical device's actual load status over the same predetermined period shown in (a) in FIG. 4. Note that in the example of (b) in FIG. 4, the predetermined period is divided into three subperiods, and an example showing the obtainment of physical device's load status for each of the three subperiods is illustrated. The three subperiods in which the physical device's load status is obtained and the three subperiods illustrated in (a) in FIG. 4 are the same subperiods.

Referring again to FIG. 3, next, calculator 220 calculates the device usage rate using a predetermined method (for example, using a predetermined calculation formula), and creator 230 creates display data to be displayed to the user based on the device usage rate of each virtual machine (S40).

In step S40, calculator 220 calculates the device usage rate of each virtual machine based on the information obtained in steps S10 to S30 and Equation 1 mentioned above. Creator 230 creates display data for visualizing the device usage rate of each virtual machine, based on the device usage rates for those virtual machines. In the example illustrated in FIG. 1, creator 230 creates display data for visualizing the load of at least one of GPU 150, storage 152, or DSP 153.

In (c) in FIG. 4, the device usage rate (as a percentage) is represented on the vertical axis of the graph.

As illustrated in (c) in FIG. 4, creator 230 may create display data showing, in a line graph, system-wide load (the actual load status of the monitored physical device, i.e., physical device usage rate) and the load of each virtual machine (device usage rate). This enables a clear understanding at a glance of which virtual machine has the higher load ratio at each time point.

Thus, the display data may be data for separately visualizing the processing load of management virtual machine 120 and the processing load of each control virtual machine. In an onboard vehicle setting, system-wide resources are limited, and it is required not only to visualize the processing amount placed on a physical device by the virtual machines, but also to visualize, as a whole system, the load each virtual machine places on the system. The display data shown in (c) in FIG. 4 is data in which requested processing from each control virtual machine processed by management virtual machine 120 is accounted for as the load for each control virtual machine, and data in which the load of application 124 within management virtual machine 120 itself has been visualized. This demonstrates that data that meets the requirements in an onboard vehicle setting has been visualized.

Note that time interval T indicates a subperiod. Time interval T is, for example, several to several hundred milliseconds, but may also be several seconds.

Referring again to FIG. 3, next, outputter 240 outputs the display data created by creator 230 to display device 300 (S50). This enables display device 300 to display, for example, the graph shown in (c) in FIG. 4.

Next, outputter 240 outputs a reset signal for the counter value to ECU 10 (S60). This enables resetting of the counter values of each process monitor in management virtual machine 120. Each process monitor includes N process monitors, including first process monitor 123a and N-th process monitor 123n, and app process monitor 125.

Next, visualization processing device 200 waits for a given period of time (S70), and then returns to step S10 to continue processing. The given period may, for example, be the duration required for measuring counter values for performing the subsequent display.

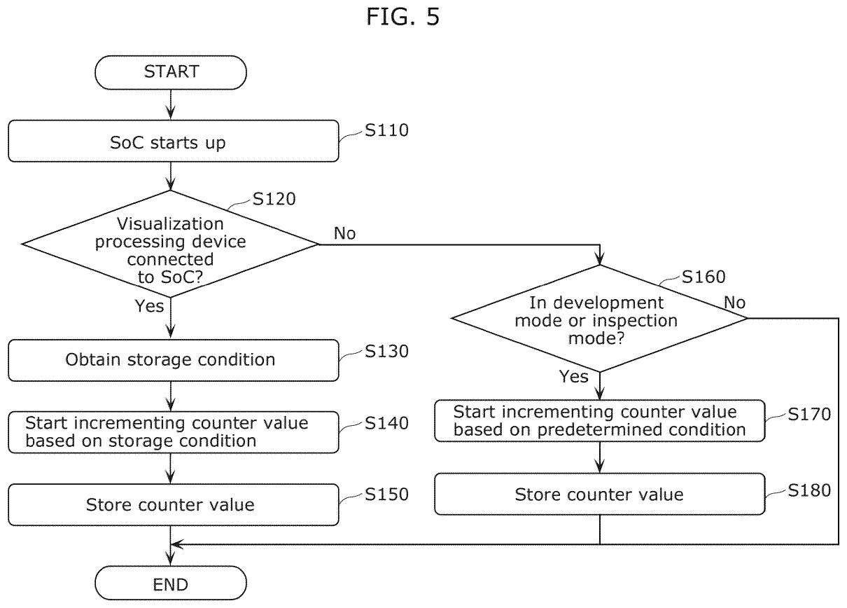

Next, operations performed by ECU 10 will be described with reference to FIG. 5. FIG. 5 is a flowchart illustrating the storage operation (monitoring method) performed by ECU 10 according to the present embodiment.

As illustrated in FIG. 5, first, SoC 100 starts up (S110). In other words, ECU 10 starts up.

Next, ECU 10 determines whether visualization processing device 200 is connected to SoC 100 (S120). ECU 10 may perform the determination of step S120 according to whether it is capable of communicating with visualization processing device 200 or not.

Next, when ECU 10 determines that visualization processing device 200 is connected to SoC 100 (Yes in S120), ECU 10 obtains a storage condition from visualization processing device 200 (S130). ECU 10 may store the storage condition in the storage unit.

The storage condition is a condition under which each process monitor counts the counter value, and may be, for example, time interval T as illustrated in (c) in FIG. 4, namely, the time interval for measuring counter values (sampling interval), or the length of the predetermined period (sampling time). The storage condition is a condition used in common by each process monitor.

Note that the storage condition may be obtained periodically, or obtained by being transmitted from visualization processing device 200 whenever it is changed. For example, when visualization processing device 200 is displaying the display data as illustrated in (c) in FIG. 4 on display device 300, and a user zooms in on the graph, the time interval corresponding to the display of the counter value shortens. Stated differently, the sampling interval of the counter value shortens. For example, when visualization processing device 200 is displaying the display data as illustrated in (c) in FIG. 4 on display device 300, and a user zooms out on the graph, the time interval corresponding to the display of the counter value becomes longer. Stated differently, the sampling time for the counter value for displaying one unit of display data becomes longer. The sampling interval and sampling time settings may also be changed by the user. In step S130, if the storage condition has changed in this manner, the changed storage condition is also obtained.

Next, each process monitor starts the incrementing of the counter value based on the storage condition (S140). Each process monitor starts counting the counter value based on the same storage condition. System load monitor 126 may start monitoring the usage rate of the physical device based on the storage condition. Thus, the measurement of the first counter value, second counter value, and third counter value is executed in coordination with visualization processing device 200 in cases in which the control device is connected to visualization processing device 200.

System load monitor 126 may, for example, obtain the actual usage rate of the physical device at time intervals T over a predetermined period as indicated by the storage condition.

Next, each process monitor stores the measured counter value in the storage unit based on the storage condition (S150). This enables the obtainment of counter values measured using the same storage condition.

When ECU 10 determines that visualization processing device 200 is not connected to SoC 100 (No in S120), ECU 10 determines whether the current operating mode is development mode or inspection mode (S160). The development mode is the operating mode of ECU 10 during its development. The operating mode can be determined to be development mode when ECU 10 is mounted while a physical switch that is dedicated to the development mode and is included in ECU 10 is pressed, when a development mode-specific program is running, or when a predetermined command is input, for example. The inspection mode is the operating mode of a vehicle, mounted with ECU 10, used during inspection. The operating mode can be determined to be inspection mode when ECU 10 is mounted while a physical switch that is dedicated to the inspection mode and is included in ECU 10 is pressed, when an inspection mode-specific program is running, or when a predetermined command is input, for example.

When ECU 10 determines that it is in development mode or inspection mode (Yes in S160), it starts the incrementing of the counter value based on a predetermined condition (S170). Since ECU 10 cannot obtain the storage condition from visualization processing device 200, it starts incrementing the counter value based on a predetermined condition. Thus, the measurement of the first counter value, second counter value, and third counter value is executed when the control device is operating in development mode or inspection mode.

The predetermined condition is a condition used in common by each process monitor. Note that a previously obtained storage condition may be used as the predetermined condition. Moreover, different storage conditions may be used in the development mode and inspection mode.

This enables measurement of counter values in the development stage of a vehicle or during vehicle inspection.

Next, each process monitor stores the measured counter value in the storage unit based on the predetermined condition (S180). This enables the obtainment of counter values measured using the same predetermined condition.

When ECU 10 determines that it is neither in development mode nor inspection mode (No in S160), it ends the processing without starting the incrementing of the counter value.

The counter values measured in this manner are output to visualization processing device 200.

The physical devices subject to monitoring may be changed in each of the development mode, inspection mode, as well as the normal use mode after sale of the vehicle. For example, the number of physical devices subject to monitoring in the normal use mode may be fewer compared to the development mode and inspection mode. Note that counter values obtained in development mode are used for improvement in the development stage, counter values obtained in inspection mode are used for vehicle inspections at dealerships, etc., and counter values obtained in normal use mode can be used for analyzing malfunctions in the market, confirming changes in device usage rates after updates to each application, and so forth. The applications include applications 124, 131, and 141.

### Embodiment Variations

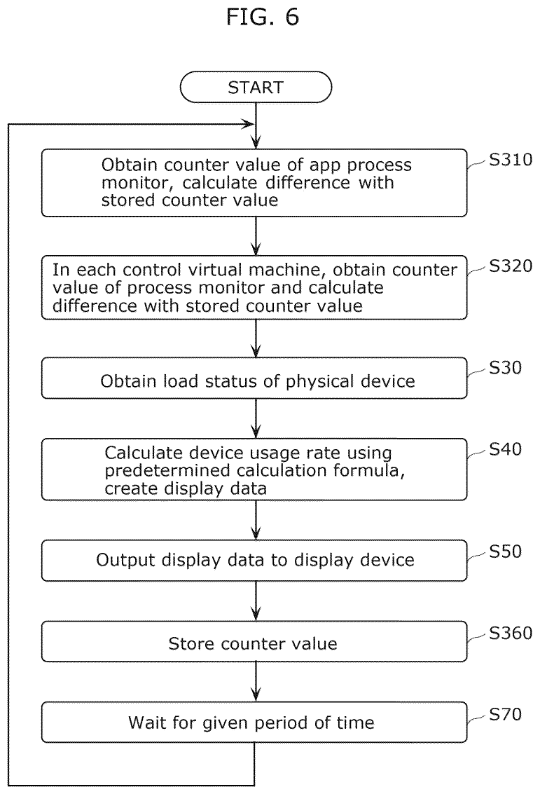

Hereinafter, the monitoring system according to the present variation will be described with reference to FIG. 6. Note that hereinafter, the description focuses primarily on the differences from the embodiment, and content identical or similar to the embodiment will be omitted or summarized for brevity. The configuration of the monitoring system according to the present variation may be the same as that of monitoring system 1 according to the embodiment, and the explanation thereof will be omitted. The following description will use the same reference signs used in monitoring system 1 according to the embodiment.

FIG. 6 is a flowchart illustrating operations (the monitoring method) performed by monitoring system 1 according to the present variation. The present variation differs from monitoring system 1 according to the embodiment in that the process monitors have counter values that are non-resettable or are configured to not be reset.

As illustrated in FIG. 6, obtainer 210 of visualization processing device 200 obtains the counter value (third counter value) of app process monitor 125, and calculator 220 calculates the difference between the obtained counter value (third counter value) and a stored counter value (third counter value) (S310). Calculator 220 calculates the difference between the latest third counter value obtained by obtainer 210 and a third counter value previously obtained by obtainer 210 and stored in the storage unit (for example, the most recent one before the latest third counter value). Calculator 220 calculates the difference by subtracting the stored third counter value from the latest third counter value obtained by obtainer 210. This makes it possible to determine how much the counter value for application 124 has incremented over a predetermined period.

Next, obtainer 210 obtains the counter value of the process monitor of each control virtual machine, and calculator 220 calculates the differences between the obtained counter values and stored counter values (S320). Calculator 220 calculates the difference between the latest counter value obtained by obtainer 210 and a counter value previously obtained by obtainer 210 and stored in the storage unit (for example, the most recent one before the latest counter value). Calculator 220 calculates the difference by subtracting the stored counter value from the latest counter value obtained by obtainer 210. For example, taking control virtual machine 130 as an example, calculator 220 calculates the difference for control virtual machine 130 by subtracting the most recent stored first counter value from the first counter value of the count by first process monitor 123a and obtained by obtainer 210. Moreover, for example, taking control virtual machine 140 as an example, calculator 220 calculates the difference for control virtual machine 140 by subtracting the most recent stored second counter value from the second counter value of the count by N-th process monitor 123n and obtained by obtainer 210.

This makes it possible to determine how much the counter value for each control virtual machine has incremented over a predetermined period.

In step S40, the device usage rate is calculated using the differences calculated in steps S310 and S320.

Visualization processing device 200 stores the counter values obtained in steps S310 and S320 in the storage unit (S360). The stored counter values are used to calculate the difference with counter values obtained at the next timing.

By operating in this manner, even when each process monitor has counter values that are non-resettable or configured to not be reset, visualization processing device 200 can calculate the device usage rate for each control virtual machine.

### Other Embodiments

One or more embodiments and the like have been described above as one or more examples of the techniques according to the present disclosure. However, the techniques according to the present disclosure are not limited to these examples; various changes, substitutions, additions, omissions, etc., may be applied to the embodiments. For example, the following variations are also included in an embodiment of the present disclosure.

For example, in the embodiment and the like described above, an example is given in which calculator 220 calculates the usage rate (one example of processing load) in each control virtual machine of the physical device shared between the control virtual machines using at least the counter value of each control virtual machine, but this example is non-limiting. Calculator 220 may calculate the usage rate in each control virtual machine and the management virtual machine of the physical device shared by the control virtual machines and the management virtual machine based on the processing amount placed on the physical device by each control virtual machine and the management virtual machine. Thus, the calculator may calculate the device usage rate in each control virtual machine and the management virtual machine of the physical device using the respective processing amounts of the control virtual machines and the management virtual machine, without using counter values. Note that the measurement method for the processing amount is not particularly limited, and any known method may be used.

Such a monitoring system monitors the processing load placed on a physical device equipped in a vehicle including a first controller and a second controller that perform control related to the physical device, and a manager that manages communication between the first and second controllers and the physical device, and includes: an obtainer that obtains a first processing amount of a predetermined process the first controller causes the physical device to execute, a second processing amount of the predetermined process the second controller causes the physical device to execute, and a third processing amount of the predetermined process the manager causes the physical device to execute; and a calculator that calculates the usage rate of the physical device in each of the first controller, the second controller, and the manager based on the obtained first, second, and third processing amounts. The monitoring system may be realized as a system including such an obtainer and a calculator.

This makes it possible to know the load ratio for each control virtual machine and the management virtual machine with respect to the system-wide load, in turn making it possible to obtain a more accurate load ratio.

In the embodiment and the like, and example is given in which the physical device, management virtual machine 120, and the control virtual machines are equipped in a vehicle, but this example is non-limiting. The object in which a physical device, management virtual machine 120, and the plurality of control virtual machines are equipped may be some other mobile object besides a vehicle such as a train or aircraft, or electrical equipment such as a cellular phone or home appliance, or some other object not included in the referenced categories, such as an Internet of Things (IoT) device, etc.

In the embodiment and the like, an example is given in which ECU 10 is realized as an integrated ECU, but this example is non-limiting; ECU 10 may be realized as a zone ECU or some other ECU.

Moreover, for example, visualization processing device 200 and display device 300 in the embodiment may be equipped in a vehicle, and may be provided external to the vehicle.

In the above embodiment and the like, each element may be configured using dedicated hardware, or may be implemented by executing a software program suitable for the element. Each element may be implemented by a program executor such as a CPU or a processor reading and executing a software program recorded on a recording medium such as a hard disk or semiconductor memory.

The order in which the steps are executed in the flow charts are mere examples presented for illustrative purposes; the steps may be executed in a different order. Moreover, some of the steps may be executed at the same time as (in parallel with) other steps, and some of the steps may be omitted.

Moreover, the division of the function blocks in the block diagrams are mere examples. A plurality of function blocks may be realized as a single function block, a single function block may be divided into a plurality of function blocks, or a portion of functions of one block may be transferred to a different function block. A plurality of function blocks which share similar functions can be processed by standalone hardware or software in parallel or time-shared.

Visualization processing device 200 according to the above embodiment and the like may be implemented as a single device, and, alternatively, may be implemented by a plurality of devices. When visualization processing device 200 is implemented by a plurality of devices, the elements included in visualization processing device 200 may be distributed among the plurality of devices in any manner. When visualization processing device 200 is implemented by a plurality of devices, the communication method between the plurality of devices is not particularly limited, and may be wireless or wired communication. A combination of wireless communication and wired communication may be used between the devices.

Each element described in the embodiment and the like may be implemented as software, and typically, may be implemented as an LSI circuit, which is an integrated circuit. These elements may be integrated into individual chips, or a portion or all of the elements may be integrated into one chip. Although the term LSI is used here, depending on the degree of integration, it may also be referred to as an IC, system LSI, super LSI, or ultra LSI. Circuit integration methods are not limited to LSI; the elements may be implemented using dedicated circuits (general-purpose circuits that execute dedicated programs) or a general-purpose processor. A field programmable gate array (FPGA) which allows programming after manufacturing of the LSI circuits or a reconfigurable processor which allows reconfiguration of the connections or settings of circuit cells inside the LSI circuits may be used. Furthermore, if a new technology for circuit integration that replaces LSI emerges due to advances in semiconductor technology or other derived technologies, it goes without saying that the elements may be integrated using that technology.

One aspect of the present disclosure may be a computer program that causes a computer to execute each of the characteristic steps included in any of the monitoring methods illustrated in FIG. 3, FIG. 5, and FIG. 6.

For example, the program may be a program for causing a computer to execute instructions. One aspect of the present disclosure may be a computer-readable non-transitory recording medium on which such a program is recorded. For example, such a program may be recorded on the recording medium and distributed or circulated. For example, by installing the distributed program on a device having another processor and causing that processor to execute the program, it becomes possible to cause that device to perform each of the above-described processes.

Embodiments arrived at by a person skilled in the art making various modifications to the embodiment and the like, or embodiments realized by arbitrarily combining elements and functions in the embodiment and the like which do not depart from the essence of the present disclosure are also included in the present disclosure.

### Additional Remarks

The following techniques are disclosed by the above embodiment and the like.
(Technique 1) Monitoring system 1 that monitors a processing load of a physical device equipped in a vehicle including a first controller and a second controller that are configured to cause the physical device to execute a process, monitoring system 1 including: obtainer 210 configured to obtain a first counter value and a second counter value, the first counter value being a count of executions of a predetermined process that the first controller causes the physical device to execute, the second counter value being a count of executions of the predetermined process that the second controller causes the physical device to execute; and calculator 220 configured to calculate a usage rate of the physical device in each of the first controller and the second controller based on the first counter value obtained and the second counter value obtained.

This makes it possible to calculate the usage rate of a physical device in each controller using counter values. Therefore, since there is no need to measure the detailed processing loads of physical device in the first controller and the second controller, the usage rate of physical device can be easily calculated. For example, conventionally, the processing load would have been measured using a dedicated measurement system (electronic circuit) embedded as hardwired logic within SoC 100. However, according to monitoring system 1, the usage rate of a physical device can be calculated simply by modifying a program. Therefore, since there is no need to provide a measurement system embedded in SoC 100 as hardwired logic, the usage rate of a physical device in each virtual machine can be easily calculated. Since it is realized by a program, updates are easy to implement.
(Technique 2) Monitoring system 1 according to Technique 1, wherein the calculator is configured to calculate a first usage rate of the physical device in the first controller based on the first counter value and a sum of the first counter value and the second counter value, and calculate a second usage rate of the physical device in the second controller based on the second counter value and the sum.

This makes it possible to calculate the physical device usage rate for each virtual machine simply by calculating the ratio of counter values.
(Technique 3) Monitoring system 1 according to Technique 1 or 2, wherein the vehicle further includes a manager configured to manage communication between the first controller and the physical device and communication between the second controller and the physical device, the manager includes a first monitor and a second monitor, the first monitor configured to count the executions of the predetermined process that the first controller causes the physical device to execute, the second monitor configured to count the executions of the predetermined process that the second controller causes the physical device to execute, and the obtainer is configured to obtain a counter value of the count by the first monitor as the first counter value and obtain a counter value of the count by the second monitor as the second counter value.

This makes it possible for the manager, using counter values counted by its monitors, to easily calculate the usage rate of a physical device.
(Technique 4) Monitoring system 1 according to Technique 3, wherein the manager further includes an application that causes the physical device to execute the process, the obtainer is further configured to obtain a third counter value of a count of executions of the predetermined process that the application causes the physical device to execute, and the calculator is configured to calculate the usage rate of the physical device in each of the first controller, the second controller, and the manager further based on the third counter value.

This makes it possible to calculate the usage rate of a physical device, including the number of times the manager causes a predetermined process to be executed on a physical device, thus accurately calculating the breakdown of the system-wide processing load. For example, when the processing load from application of the manager is large, it becomes possible to detect that the manager itself is a bottleneck.
(Technique 5) Monitoring system 1 according to Technique 4, wherein the calculator is configured to calculate a third usage rate of the physical device in the manager based on the third counter value and a sum of the first counter value, the second counter value, and the third counter value.

This makes it possible to calculate the physical device usage rate in the manager simply by calculating the ratio of counter values.
(Technique 6) Monitoring system 1 according to any one of Techniques 1 to 5, further including: a display (display device 300) configured to display the usage rate of the physical device in each of the first controller and the second controller calculated by the calculator.

This makes it possible to visualize the calculated physical device usage rate.
(Technique 7) Monitoring system 1 according to any one of Techniques 1 to 6, further including: a control device including at least the first controller and the second controller; and a processing device including at least the obtainer and the calculator, wherein measurement of the first counter value and the second counter value is executed on condition that the control device is connected to the processing device.

This makes it possible to easily obtain the usage rate of a physical device when the control device and processing device are connected.
(Technique 8) Monitoring system 1 according to any one of Techniques 1 to 7, further including: a control device including at least the first controller and the second controller, wherein measurement of the first counter value and the second counter value is executed on condition that the control device is operating in a development mode or an inspection mode.

This makes it possible to easily obtain the usage rate of a physical device when the control device is operating in development mode or inspection mode.
(Technique 9) A monitoring device (for example, management virtual machine 120) for monitoring a processing load of a physical device equipped in a vehicle including a first controller and a second controller that are configured to cause the physical device to execute a process, the monitoring device including: a first monitor configured to count executions of a predetermined process that the first controller causes the physical device to execute; a second monitor configured to count executions of the predetermined process that the second controller causes the physical device to execute; and an outputter configured to output a first counter value of the count by the first monitor and a second counter value of the count by the second monitor.

With this, by calculating the physical device usage rate for each machine using the calculated first and second counter values, the physical device usage rate per virtual machine can be easily calculated without having to measure the detailed physical device processing load in the first and second controllers.
(Technique 10) The monitoring device according to Technique 9, further including: an application that causes the physical device to execute the process; and a third monitor configured to count executions of the predetermined process that the application causes the physical device to execute, wherein the outputter is further configured to output a third counter value of the count by the third monitor.

This makes it possible to calculate the usage rate of a physical device, including the third counter value, thus accurately calculating the breakdown of the system-wide processing load.
(Technique 11) A monitoring method of monitoring a processing load of a physical device equipped in a vehicle including a first controller and a second controller that cause the physical device to execute a process, the monitoring method including: obtaining a first counter value and a second counter value, the first counter value being a count of executions of a predetermined process that the first controller causes the physical device to execute, the second counter value being a count of executions of the predetermined process that the second controller causes the physical device to execute; and calculating a usage rate of the physical device in each of the first controller and the second controller based on the first counter value obtained and the second counter value obtained.

This achieves the same advantageous effect as the above-described monitoring system 1.
(Technique 12) A non-transitory computer-readable recording medium for use in a computer, the recording medium having a computer program recorded thereon for causing the computer to execute the monitoring method according to Technique 11.

This achieves the same advantageous effect as the above-described monitoring system 1.

### Further Information about Technical Background to this Application

The disclosures of the following patent applications including specification, drawings and claims are incorporated herein by reference in their entirety: Japanese Patent Application No. 2023-199149 filed on Nov. 24, 2023.

### INDUSTRIAL APPLICABILITY

The present disclosure is applicable to monitoring systems and the like used in vehicles.

1. A monitoring system that monitors a processing load of a physical device equipped in a vehicle including a first controller and a second controller that are configured to cause the physical device to execute a process, the monitoring system comprising:
an obtainer configured to obtain a first counter value and a second counter value, the first counter value being a count of executions of a predetermined process that the first controller causes the physical device to execute, the second counter value being a count of executions of the predetermined process that the second controller causes the physical device to execute; and
a calculator configured to calculate a usage rate of the physical device in each of the first controller and the second controller based on the first counter value obtained and the second counter value obtained.

2. The monitoring system according to claim 1, wherein
the calculator is configured to calculate a first usage rate of the physical device in the first controller based on the first counter value and a sum of the first counter value and the second counter value, and calculate a second usage rate of the physical device in the second controller based on the second counter value and the sum.

3. The monitoring system according to claim 1, wherein
the vehicle further includes a manager configured to manage communication between the first controller and the physical device and communication between the second controller and the physical device,
the manager includes a first monitor and a second monitor, the first monitor configured to count the executions of the predetermined process that the first controller causes the physical device to execute, the second monitor configured to count the executions of the predetermined process that the second controller causes the physical device to execute, and
the obtainer is configured to obtain a counter value of the count by the first monitor as the first counter value and obtain a counter value of the count by the second monitor as the second counter value.

4. The monitoring system according to claim 3, wherein
the manager further includes an application that causes the physical device to execute the process,
the obtainer is further configured to obtain a third counter value of a count of executions of the predetermined process that the application causes the physical device to execute, and
the calculator is configured to calculate the usage rate of the physical device in each of the first controller, the second controller, and the manager further based on the third counter value.

5. The monitoring system according to claim 4, wherein
the calculator is configured to calculate a third usage rate of the physical device in the manager based on the third counter value and a sum of the first counter value, the second counter value, and the third counter value.

6. The monitoring system according to claim 1, further comprising:
a display configured to display the usage rate of the physical device in each of the first controller and the second controller calculated by the calculator.

7. The monitoring system according to claim 1, further comprising:
a control device including at least the first controller and the second controller; and
a processing device including at least the obtainer and the calculator, wherein
measurement of the first counter value and the second counter value is executed on condition that the control device is connected to the processing device.

8. The monitoring system according to claim 1, further comprising:
a control device including at least the first controller and the second controller, wherein
measurement of the first counter value and the second counter value is executed on condition that the control device is operating in a development mode or an inspection mode.

9. The monitoring system according to claim 2, wherein
the vehicle further includes a manager configured to manage communication between the first controller and the physical device and communication between the second controller and the physical device,
the manager includes a first monitor and a second monitor, the first monitor configured to count the executions of the predetermined process that the first controller causes the physical device to execute, the second monitor configured to count the executions of the predetermined process that the second controller causes the physical device to execute, and
the obtainer is configured to obtain a counter value of the count by the first monitor as the first counter value and obtain a counter value of the count by the second monitor as the second counter value.

10. The monitoring system according to claim 2, further comprising:
a display configured to display the usage rate of the physical device in each of the first controller and the second controller calculated by the calculator.

11. The monitoring system according to claim 2, further comprising:
a control device including at least the first controller and the second controller, and
a processing device including at least the obtainer and the calculator, wherein
measurement of the first counter value and the second counter value is executed on condition that the control device is connected to the processing device.

12. The monitoring system according to claim 2, further comprising:
a control device including at least the first controller and the second controller, wherein
measurement of the first counter value and the second counter value is executed on condition that the control device is operating in a development mode or an inspection mode.

13. The monitoring system according to claim 1, wherein the predetermined process includes at least one of transferring an image, deleting data, or filtering digital data.

14. The monitoring system according to claim 1, wherein
the calculator is configured to:
calculate a first usage rate of the physical device based on the usage rate of the physical device and a ratio of the first counter value to a sum of the first counter value and the second counter value; and
calculate a second usage rate of the physical device based on the usage rate of the physical device and a ratio of the second counter value to the sum of the first counter value and the second counter value.

15. The monitoring system according to claim 1, wherein
the physical device includes at least one of a graphics processing unit (GPU), a storage, or a digital signal processor (DSP).

16. The monitoring system according to claim 9, further comprising:
a control device including at least the first controller and the second controller; and
a processing device including at least the obtainer and the calculator, wherein
the control device obtains, from the processing device, a storage condition common to the first monitor and the second monitor and indicating a condition under which the first monitor and the second monitor count a counter value, and
the storage condition includes at least one of a time interval for measuring the counter value or a sampling time for measuring the counter value.

17. A monitoring device for monitoring a processing load of a physical device equipped in a vehicle including a first controller and a second controller that are configured to cause the physical device to execute a process, the monitoring device comprising:
a first monitor configured to count executions of a predetermined process that the first controller causes the physical device to execute;
a second monitor configured to count executions of the predetermined process that the second controller causes the physical device to execute; and
an outputter configured to output a first counter value of the count by the first monitor and a second counter value of the count by the second monitor.

18. The monitoring device according to claim 17, further comprising:
an application that causes the physical device to execute the process; and
a third monitor configured to count executions of the predetermined process that the application causes the physical device to execute, wherein
the outputter is further configured to output a third counter value of the count by the third monitor.

19. A monitoring method of monitoring a processing load of a physical device equipped in a vehicle including a first controller and a second controller that cause the physical device to execute a process, the monitoring method comprising:
obtaining a first counter value and a second counter value, the first counter value being a count of executions of a predetermined process that the first controller causes the physical device to execute, the second counter value being a count of executions of the predetermined process that the second controller causes the physical device to execute; and
calculating a usage rate of the physical device in each of the first controller and the second controller based on the first counter value obtained and the second counter value obtained.

20. A non-transitory computer-readable recording medium for use in a computer, the recording medium having a computer program recorded thereon for causing the computer to execute the monitoring method according to claim 19.
